(19) United States
(12) Patent Application Publication
(10) Pub. No.: US 2019/0135050 A1
(43) Pub. Date: May 9, 2019

(54) PNEUMATIC TIRE FOR HEAVY LOADS

(71) Applicant: Toyo Tire & Rubber Co., Ltd., Itami-shi (JP)

(72) Inventor: Yuji Izuhara, Itami-shi (JP)

(73) Assignee: Toyo Tire & Rubber Co., Ltd., Itami-shi (JP)

(21) Appl. No.: 16/163,058

(22) Filed: Oct. 17, 2018

(30) Foreign Application Priority Data
Nov. 9, 2017 (JP) 2017-216777

(51) Int. Cl. B60C 15/06; B60C 9/20; B60C 9/22; B60C 9/18

(52) U.S. Cl. CPC B60C 15/0603; B60C 9/2006; B60C 2009/2067; B60C 9/185; B60C 2200/06; B60C 9/22

(57) ABSTRACT

A pneumatic tire for heavy loads comprising a bead core, a bead filler arranged on the outside in a tire radial direction of the lead core, a steel cord-containing carcass ply wound up on the outside from the inside in a fire axis direction around the bead core, a steel cord-containing chafer provided so as to cover the carcass ply from the inside in the tire radial direction, and a reinforcing sheet comprising a rubber and a cotton kneaded therein and interposed between the bead core and the carcass ply. The tire can improve durability of a bead part.

### CROSS-REFERENCE TO RELATED APPLICATIONS

This application is based upon and claims the benefit of priority from the prior Japanese Patent Application No. 2017-216777, filed on Nov. 9, 2017; the entire contents of which are incorporated herein by reference.

### BACKGROUND

### 1. Technical Filed

Embodiments of the present invention relates to a pneumatic tire for heavy loads.

### 2. Related Art

It is known in a pneumatic tire for heavy loads used in trucks, buses and the like that a flipper is interposed as a reinforcing sheet between a bead core and a carcass ply in order to improve durability of a bead part. The flipper increases rigidity of the whole bead part and additionally prevents friction between a bead core and a carcass ply, thereby suppressing damage of the carcass ply. The conventional flipper comprises organic fiber cords aligned such as nylon fiber cords and a rubber as a topping thereon. In this case, rigidity of the bead part can be increased, but due to the cords having an angle, strain concentrates in a flipper end (that is, an edge of a reinforcing sheet) and this may cause fault occurrence of a tire.

JP-A-2003-237324 describes that a bead cover (reinforcing sheet) comprising a short fiber-containing rubber is interposed between a carcass ply containing a steel cord and a bead core. However; short fibers having high rigidity such as carbon fibers or aramid fibers are used as the short fibers and the patent document does not describe that cotton is contained.

On the other hand, JP-A-2001-138720 describes that a short fiber-containing rubber is provided on a bead part. However, the invention disclosed relates to a bead-reinforced rubber layer corresponding to a bead filler and does not relate to a reinforcing sheet interposed between a bead core and a carcass ply.

### SUMMARY

An object of an embodiment of the present invention is to provide a pneumatic tire for heavy loads having a reinforcing sheet preventing friction between a bead core and a carcass ply capable of suppressing damage in an edge of the reinforcing sheet and improving durability of a bead part.

The pneumatic tire for heavy loads according to an embodiment of the present invention includes a bead core embedded in a bead part, a bead filler arranged on the outside in a tire radial direction of the bead core, a steel cord-containing carcass ply wound up on the outside from the inside in a tire axis direction around the bead core, a steel cord-containing chafer provided so as to cover the carcass ply from the inside in a the radial direction in the bead part, and a reinforcing sheet comprising a rubber and a cotton kneaded therein and interposed between the bead core and the carcass ply.

According to the present invention, friction between a bead core and a carcass ply can be prevented by a reinforcing sheet comprising a rubber and a cotton kneaded therein, and in addition to this, fault in an edge of the reinforcing sheet can be suppressed and durability of the bead part can be enhanced.

### BRIEF DESCRIPTION OF THE DRAWINGS

FIG. 1 is a cross-sectional view of a bead part of a pneumatic the according to an embodiment (Example 1).

FIG. 2 is a cross-sectional view of a bead part of the pneumatic the according to Example 2.

FIG. 3 is a cross-sectional view of a bead part of the pneumatic tire according to Example 3.

FIG. 4 is a cross-sectional view of a bead part, of She pneumatic tire according to Example 4.

FIG. 5 is a cross-sectional view of a bead part of the pneumatic tire according to Example 5.

### DETAILED DESCRIPTION

Embodiments are described below by reference to the drawings.

In the present specification, the term “tire axis direction” is a direction parallel to a tire rotation axis, is synonymous with a tire width direction and is shown by a mark Y in the drawings. The term “the inside in a tire axis direction” means a direction approaching a tire equatorial plane in a tire axis direction and is shown by a mark Yi in the drawings. The term “the outside in a tire axis direction” is a direction going away from the tire equatorial plane in a tire axis direction and is shown by a mark Yo. The term “tire radial direction (radial direction)” is a direction vertical to a tire rotation axis and is shown by a mark Z. The term “the inside in a tire radial direction” is a direction approaching a tire rotation axis in a the radial direction and is shown by a mark Zi. The term “the outside in a the radial direction” is a direction going away from a the rotation axis in a tire radial direction and is shown by a mark Zo.

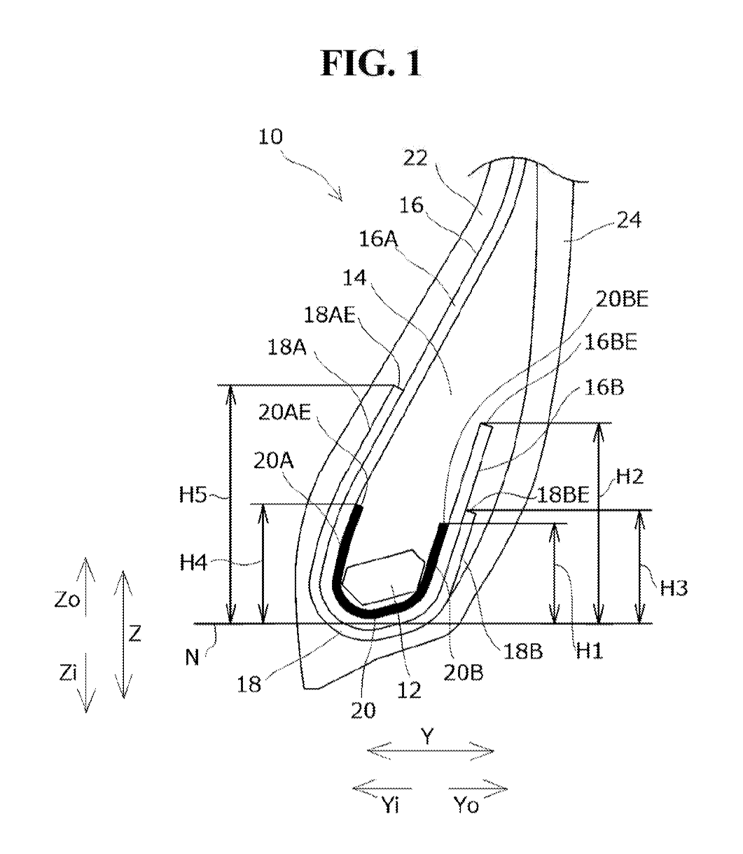

The pneumatic tire according to an embodiment is a tire for heavy loads used in trucks or buses and comprises a pair of left and right bead parts, a pair of sidewall parts extending to the outside in a tire radial direction from the bead part, and a tread part provided between both sidewall parts so as to connect outer edges in a tire radial direction of the left and right sidewalls to each other. This embodiment has the characteristic in the constitution of the bead part. The constitution other than the bead part is not particularly limited and can use the conventional constitution. The constitution of the bead part is described below by reference to FIG. 1.

A ring-shaped bead core 12 comprising a bundle of rubber-covered bead wires laminated and wound and a ring-shaped rubber bead filler 14 arranged on the outside in a tire radial direction of the bead core 12 are embedded in a bead part 10 as shown in FIG. 1. The bead core 12 has a hexagonal cross-section in this embodiment, but may have other polygonal shape. The cross-section is not particularly limited. The bead filler 14 is a hard rubber member extending to the outside in a tire radial direction from the outer surface in a tire radial direction of the bead core 12 and is formed to have a cross-section tapered toward the tip.

A carcass ply 16 across in a toroidal shape between a pair of the bead parts 10 is embedded in the pneumatic tire. The carcass ply 16 extends through a sidewall part from a tread part not shown and both edges thereof are locked in the bead part 10. The carcass ply 16 comprises ply cords arranged in a direction nearly vertical (80° to 90°) to a tire circumferential direction, covered with a topping rubber. In this embodiment the ply cord is a steel cord. Specifically the carcass ply 16 is a steel carcass ply.

The carcass ply 16 is wound up outside from the inside in a tire axis direction around the bead core 12. In detail, the carcass ply 16 is that a main body part 16A thereof extended from a tread part is provided along inner surfaces in a tire axis direction of the bead core 12 and the bead filler 14 and is wound up outside through the lower side of the bead core 12 (that is, turned up). A wind-up part 16B thereof is provided along outer surfaces in a the axis direction of the bead core 12 and the bead filler 14 and its tip (that is, the upper edge of the wind-up part 16B) constitutes a wind-up edge 16BE.

A steel cord-containing chafer 18 is embedded around the carcass ply 16 in the bead part 10. The chafer 18 is provided so as to cover the turned-up part of the carcass ply 16 over the whole circumference of the bead part 10 from the inside in a tire radial direction.

The chafer 18 is a reinforcing layer using a steel cord (that is, steel chafer) and is formed by covering steel cords arranged with inclination in an inclination angle of, for example, 20° to 50° to a tire circumferential direction with a topping rubber. The chafer 18 comprises an inner portion 18A wound up on the inside in a tire axis direction of the bead core 12 along the main body part 16A of the carcass ply 16, and an outer portion 18B wound up on the outside in a tire axis direction of the bead core 12 along the wind-up part 16B of the carcass ply 16.

A reinforcing sheet 20 is interposed over the whole circumference of the bead part 10 between the bead core 12 and the carcass ply 16 as shown in FIG. 1. The reinforcing sheet 20 is a sheet-shaped member suppressing friction between the bead core 12 and the carcass ply 16 and functions as a flipper.

The reinforcing sheet 20 is provided so as to cover the bead core 12 from the inside in a tire radial direction and has a U-shaped cross-section folded at the lower surface side of the bead core 12. The reinforcing sheet 20 comprises an inner part 20A in a the axis direction wound up on the inside in a tire axis direction of the bead core 12 and an outer part 20B in a tire axis direction wound up on the outside in a tire axis direction of the bead core 12. The inner part (that is, wind-up part to the inside) 20A of the reinforcing sheet 20 is put on the inner surface in a tire axis direction of the bead filler 14 and the outer part (that is, wind-up part to the outside) 20B of the reinforcing sheet 20 is put on the outer surface in a tire axis direction of the bead filler 14. Therefore, the outer part 20B of the reinforcing sheet 20, the wind-up part 16B of the carcass ply 16 and the outer portion 18B of the chafer 18 are overlaid in this order in the outside in a tire axis direction of the bead core 12 in this example. Furthermore, the inner part 20A of the reinforcing sheet 20, the main body part 16A of the carcass ply 16 and the inner portion 18A of the chafer 18 are overlaid in this order in the inside in a tire axis direction of the bead core 12.

The reinforcing sheet 20 is a cotton-containing rubber sheet comprising a rubber and a cotton kneaded therein. The cotton may be raw cotton or cotton wool. The reinforcing sheet is reinforced by kneading cotton therein. As a result, the effect of protecting the carcass ply 16 can be increased, and this leads to the enhancement of rigidity of the bead part 10. The reinforcing sheet 20 comprising a cotton-containing rubber does not comprise cords having an angle as in the conventional flipper. Therefore, failure at the edge of the reinforcing sheet 20 can be suppressed and durability of the bead part 10 can be enhanced. Furthermore, cotton is inexpensive as compared with other short filers such as aramid fibers. Therefore, the cotton is excellent in the balance between reinforcing properties and costs. Additionally, the cotton is a natural material of non-petroleum resources and is therefore excellent in environmental properties.

Examples of the rubber in which cotton is kneaded include various after compositions generally used as a rubber composition for a tire, and the rubber is not particularly limited. A rubber component includes at least one of diene rubbers such as natural rubber (NR), styrene-butadiene rubber (SBR), butadiene rubber (BR) and isoprene rubber (IR) and preferably contains natural rubber. The rubber composition can contain various additives such as a filler such as carbon black, zinc flower, an age resister, sulfur and a vulcanization accelerator. The cotton is kneaded together with a rubber component and various additives and as a result, a cotton-containing unvulcanized robber comprising a rubber and cotton as a short fiber dispersed therein is obtained. The unvulcanized rubber is shaped into a sheet, the sheet is combined with other tire members including a bead core, the resulting assembly is molded to form a green tire and the green tire is vulcanization-molded according to the conventional method. Thus, a pneumatic tire is obtained.

Cotton content in the reinforcing sheet 20 is not particularly limited but is preferably 5 to 15 mass % based on the mass (100 mass %) of the entire reinforcing sheet 20. When the cotton content is 5 mass % or more, rigidity of the reinforcing sheet 20 is increased and a thickness between the bead core 12 and the carcass ply 16 is easily secured. On the other hand, when the cotton content is 15 mass % or less, processability of the reinforcing sheet 20 can be improved.

Rubber hardness of the reinforcing sheet 20 is not particularly limited, but is preferably 80 to 90 in terms of Durometer A hardness at ordinary temperature according to JIS K6253-3. When the reinforcing sheet 20 having the hardness is used, rigidity is increased and durability of the bead part 10 can be improved.

Thickness of the reinforcing sheet 20 is not particularly limited and may be, for example, 1.0 to 2.0 mm.

In the reinforcing sheet 20 of the present embodiment, a height of an outer edge 20BE in its tire axis direction (that is, an upper edge of the outer part 20B (an outer edge in a tire radial direction)) is set to be lower than a height of a wind-up edge 16BE of the carcass ply 16 as shown in FIG. 1. Furthermore, a height of the inner edge 20AE in a tire axis direction (that is, an upper edge of the inner part 20A) of the reinforcing sheet 20 is set to be lower than a height of a wind-up edge 16BE of the carcass ply 16. This constitution can further effectively suppress strain in the edges 20AE and 20BE of the reinforcing sheet 20. In detail, the height is preferably set as follows, considering the reinforcing effect by the reinforcing sheet 20.

Height from a nominal rim diameter N (that is, a distance in a the radial direction from a nominal rim diameter; hereinafter the same) of the outer edge 20BE in a tire axis direction of the reinforcing sheet 20 is shown as H1, a height from the nominal rim diameter N of the wind-up edge 16BE of the carcass ply 16 is shown as H2 and a height from the nominal rim diameter N of the inner edge 20AE in a tire axis direction of the reinforcing sheet 20 is shown as H4. The nominal rim diameter used herein is a rim diameter (a nominal diameter of a rim) defined in the standard of JATMA. A mark N indicates a position in a tire radial direction of an endpoint of the nominal rim diameter.

In tins case, H1, H2 and H4 satisfy the following requirements (1) and (2).

0.3≤H1/H2≤0.8 (1)

0.3≤H4/H2≤0.9 (2)

In other words, a ratio of H1 to H2 is 0.3 to 0.8 and a ratio of H4 to H2 is 0.3 to 0.9. When the ratios are set within the ranges, strain in the edges 20AE and 20BE of the reinforcing sheet 20 can be effectively suppressed while increasing the reinforcing effect by the reinforcing sheet 20. In detail, when the H1/H2 is 0.3 or more, the reinforcing effect by the reinforcing sheet 20 can be enhanced. On the other hand, when H1/H2 is 0.8 or less, a distance between the carter edge 20BE of the reinforcing sheet 20 and the wind-up edge 16BE of the carcass ply 16 is seemed and the strain suppression effect can be enhanced. Furthermore, when H4/H2 is 0.3 or more, the reinforcing effect by the reinforcing sheet 20 can be enhanced. On the other hand, when H4/H2 is 0.9 or less, a distance between the inner edge 20AE of the reinforcing sheet 20 and the inner edge 18AE of the chafer 18 is secured and the strain suppression effect can be enhanced. The H1/H2 is more preferably 0.4 to 0.6 and the H4/H2 is more preferably 0.4 to 0.8.

In the chafer 18 of the present embodiment, a height of the outer edge 18BE in its tire axis direction (that is, an upper edge of the outer portion 18B) is set to be lower than a height of the wind-tip edge 16BE of the carcass ply 16 adjacent to the inside thereof, as shown in FIG. 1. Furthermore, a height of the inner edge 18AE in a tire axis direction of the chafer 18 (that is, an upper edge of the inner portion 18A) is set to be higher than a height of the wind-up edge 16BE of the carcass ply 16. This constitution can further effectively suppress stein in the edges 18AE and 18BE of the chafer 18.

In detail, when a height from the nominal rim diameter N of the outer edge 18BE in a tire axis direction of the chafer 18 is H3 and a height from the nominal rim diameter N of the inner edge 18AE in a tire axis direction of the chafer 18 is H5, H2, H3 and H5 preferably satisfy the following requirements (3) and (4).

0.5≤H3/H2≤0.8 (3)

1.1≤H5/H2≤1.3 (4)

In other words, the ratio of H3 to H2 is 0.5 to 0.8 and the ratio of H5 to H2 is 1.1 to 1.3. When both the carcass ply 16 and the chafer 18 comprise steel cords as in the present embodiment, strain at the wind-up edge 16BE of the carcass ply 16 and the inner edge 18AE in a tire axis direction of the chafer 18 is particularly increased in the bead part 10. However, when the above requirements (1) to (4) are satisfied, the strain at the wind-up edge 16BE of the carcass ply 16 and the edges 18AE and 18BE of the chafer 18 can be effectively suppressed while suppressing the strain at the edges 20AE and 20 BE of the reinforcing sheet 20. The H3/H2 is more preferably 0.6 to 0.7. H1 and H3 may be consistent with each other and may be different.

In FIG. 1, the reference numeral 22 shows an inner liner as an air permeation-resistant rubber layer constituting an inner circumferential surface of a tire. The reference numeral 24 shows a sidewall rubber constituting an outer wall surface of a tire in a sidewall part.

Each size in the present specification is a size under an unloaded normal state in which a pneumatic tire has been mounted on a normal rim and normal inner pressure has been charged therein. The normal rim is “Standard Rim” in JATMA standard. “Design Rim” in TRA standard or “Measuring Rim” in ETRTO standard. The normal inner pressure is “Maximum Air Pressure” in JATMA standard, “Maximum Value” described in “TIRE LOAD LIMITS AT VARIOUS COLD INFLATION PRESSURES” in TRA standard or “Inflation Pressure” in ETRTO standard.

According to the present embodiment, friction between the bead core 12 and the carcass ply 16 can be prevented by the reinforcing sheet 20. The reinforcing sheet 20 comprises a rubber and cotton kneaded therein. Therefore, failure at the outer edge 20BE in a tire axis direction of the reinforcing sheet 20 can be suppressed. As a result, durability of the bead part 10 can be enhanced.

The constitution of the bead part 10 described above is preferably applied to a pair of left and right bead parts, but may be applied to either of those.

### EXAMPLE

To specifically show the constitution and effect of the present embodiment, a pneumatic radial tire for heavy loads (size: 11R22.5) was experimentally manufactured and durability of a bead part of the tire was evaluated. The evaluation method is as follows.

Durability of bead part: A tire experimentally manufactured was mounted on a rim of 22.5×7.50 and inner pressure of 900 kPa was charged in the tire. The tire was placed on a steel drum having smooth surface and a radius of 1.7 m under a load of 210% of JATMA standard load and run at a speed of 40 km/hour for 168 hours. The load applied was increased 10% every 168 hours at a constant speed and the tire was run until a bead part had broken. Room temperature was set to 40° C. The time until breaking was indicated by an index as Comparative Example 1 being 100. Durability is good as the numerical value increases.

The constitutions of the tires according to Examples 1 to 5 and Comparative Example 1 are show in Table 1. Example 1 is the example having the constitution of the bead part shown in FIG. 1. In this example, the outer edge 20BE of the reinforcing sheet 20 is lower than the inner edge 20AE and is lower than the outer edge 18BE of the chafer 18. The inner edge 20AE of the reinforcing sheet 20 is higher than the outer edge 18BE of the chafer 18. A cotton-containing rubber obtained by adding a cotton to a rubber composition for a the comprising natural rubber and carbon black as a filler added thereto and kneading the resulting mixture was used as the reinforcing sheet 20. The cotton content was 10 mass % and rubber hardness of the cotton-containing rubber was 85. Thickness of the reinforcing sheet 20 was 1.5 mm.

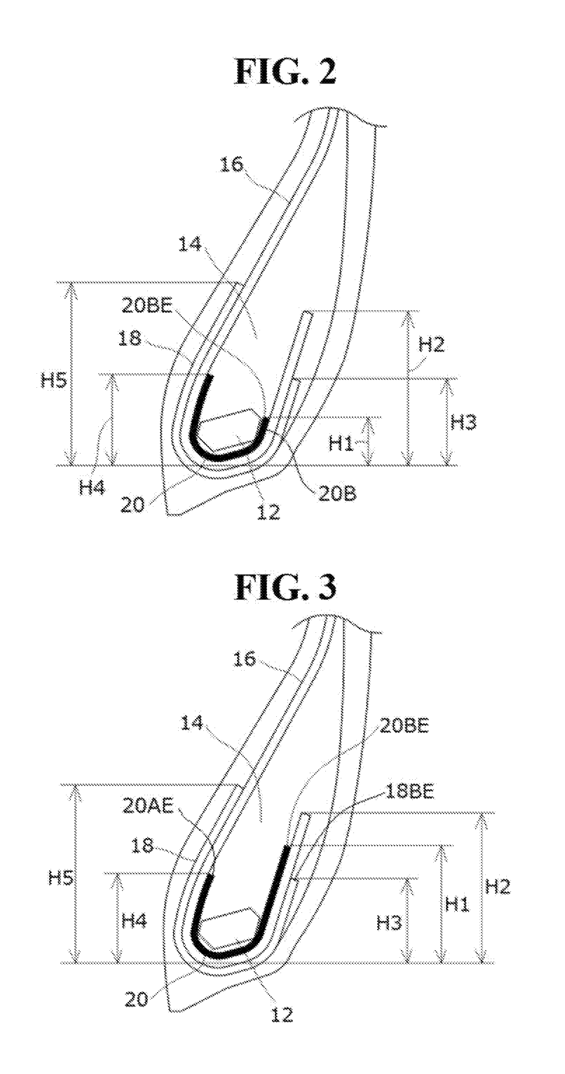

Example 2 is the example having the constitution of the bead part shown in FIG. 2, and the height H1 of the outer edge 20BE of the reinforcing sheet 20 is lower than that of Example 1. The outer part 20B of the reinforcing sheet 20 is terminated before the upper surface of the bead core 12 so as not to overlap the outer surface in a tire axis direction of the bead filler 14. Other elements are the same as in Example 1.

Example 3 is the example having the constitution of the bead part shown in FIG. 3, and the height H1 of the outer edge 20BE of the reinforcing sheet 20 is higher than that of Example 1. The outer edge 20BE is higher than the inner edge 20AE and is higher than the outer edge 18BE of the chafer 18. Other elements are the same as in Example 1.

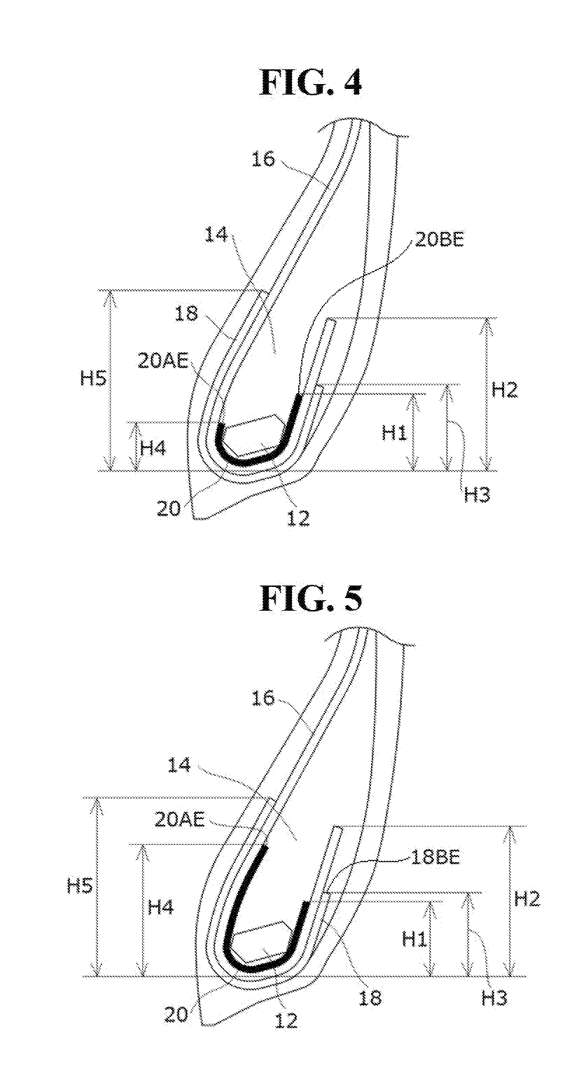

Example 4 is the example having the constitution of the bead part shown in FIG. 4, and the height H4 of the inner edge 20AE of the reinforcing sheet 20 is lower than that of Example 1. The inner edge 20AE is lower than the outer edge 20BE. Other elements are the same as in Example 1.

Example 5 is the example having the constitution of the bead part shown in FIG. 5, and the height H4 of the inner edge 20AE of the reinforcing sheet 20 is higher than that of Example 1. The inner edge 20AE is higher than the outer edge 18BE of the chafer 18. Other elements are the same as in Example 1.

Comparative Example 1 is the example using the conventional flipper (NY flipper) containing nylon cords as the reinforcing sheet 20 in the constitution shown in FIG. 1, and the elements other than the reinforcing sheet 20 had the same constitution as in Example 1.

TABLE 1

| | Comparative | | | | | |
|---|---|---|---|---|---|---|
| | Example 1 | Example 1 | Example 2 | Example 3 | Example 4 | Example 5 |
| Constitution of bead part | | | | | | |
| Cross-sectional view | FIG. 1 | FIG. 1 | FIG. 2 | FIG. 3 | FIG. 4 | FIG. 5 |
| Reinforcing sheet | NY flipper | Cotton-containing | Cotton-containing | Cotton-containing | Cotton-containing | Cotton-containing |
| | | rubber | rubber | rubber | rubber | rubber |
| H1 (mm) | 16 | 16 | 10 | 25 | 16 | 16 |
| H2 (mm) | 32 | 32 | 32 | 32 | 32 | 32 |
| H3 (mm) | 18 | 18 | 18 | 18 | 18 | 18 |
| H4 (mm) | 19 | 19 | 19 | 19 | 10 | 28 |
| H5 (mm) | 38 | 38 | 38 | 38 | 38 | 38 |
| H1/H2 | 0.5 | 0.5 | 0.3 | 0.8 | 0.5 | 0.5 |
| H4/H2 | 0.6 | 0.6 | 0.6 | 0.6 | 0.3 | 0.9 |
| H3/H2 | 0.6 | 0.6 | 0.6 | 0.6 | 0.6 | 0.6 |
| H5/H2 | 1.2 | 1.2 | 1.2 | 1.2 | 1.2 | 1.2 |
| Evaluation (index) | | | | | | |
| Durability of bead part | 100 | 120 | 112 | 116 | 112 | 118 |

As shown in Table 1, durability of the bead part could be greatly improved in Examples 1 to 5 of the present embodiment as compared with Comparative Example 1 using the conventional flipper.

Some embodiments of the present invention have teen described above, but those embodiments are described as examples and are not intended to limit the scope of the present invention. Those embodiments can be carried out in various embodiments, and various omissions, replacements and changes can be made in a range that does not deviate from the gist of the present invention. Those embodiments and modifications thereof are included in the scope and gist of the present invention and are also included in the inventions described in the claims and their equivalent ranges.

What is claimed is:

1. A pneumatic tire for heavy loads comprising:
a bead core embedded in a bead part,
a bead filler arranged on the outside in a tire radial direction of the bead core,
a steel cord-containing carcass ply wound up on the outside fixes the inside in a tire axis direction around the bead core,
a steel cord-containing chafer provided so as to cover the carcass ply from the inside in the tire radial direction in the bead part, and
a reinforcing sheet comprising a rubber and cotton kneaded therein and interposed between the bead core and the carcass ply.

2. The pneumatic tire for heavy loads according to claim 1, wherein
the reinforcing sheet is provided so as to cover the bead core from the inside in the tire radial direction,
the reinforcing sheet comprises an outer part in the tire axis direction wound up on the outside in the tire axis direction of the bead core and an inner part in tire tire axis direction wound up on the inside in the tire axis direction of the bead core,
the outer part of the reinforcing sheet is put on the outer surface in the tire axis direction of the bead filler, and
the inner part of the reinforcing sheet is put on the inner surface in the tire axis direction of the bead filler.

3. The pneumatic tire for heavy loads according to claim 1, wherein
the reinforcing sheet comprises an outer edge that is an upper edge of an outer part in the tire axis direction wound up on the outside in the tire axis direction of the bead core and an inner edge that is an upper edge of an inner part in the tire axis direction wound up on the inside in the tire axis direction of the bead core, and
a height H1 from a nominal rim diameter of the outer edge of the reinforcing sheet, a height H2 from the nominal rim diameter of a wind-up edge of the carcass ply and a height H4 from the nominal rim diameter of the inner edge of the reinforcing sheet satisfy the following requirements (1) and (2):
0.3≤H1/H2≤0.8 (1)
0.3≤H4/H2≤0.9. (2)

4. The pneumatic tire for heavy loads according to claim 3, wherein
the chafer comprises an carter edge that is an upper edge of an outer portion wound up on the outside in the tire axis direction of the bead core and an inner edge that is an upper edge of an inner portion wound up on the inside in the tire axis direction of the bead core, and
The height H2 from the nominal rim diameter of the wind-up edge of the carcass ply, a height H3 from the nominal rim diameter of the outer edge of the chafer and a height H5 from the nominal rim diameter of the inner edge of the chafer satisfy the following requirements (3) and (4);
0.5≤H3/H2≤0.8 (3)
1.1≤H5/H2≤1.3. (4)

5. The pneumatic tire for heavy loads according to claim 1, wherein the reinforcing sheet has a cotton content of 5 to 15 mass %.

6. The pneumatic tire for heavy loads according to claim 1, wherein the reinforcing sheet has rubber hardness of 80 to 90.

7. The pneumatic tire for heavy loads according to claim 1, wherein the reinforcing sheet has a thickness of 1.0 to 2.0 mm.
